(19) United States
(12) Patent Application Publication
(10) Pub. No.: US 2021/0142642 A1
(43) Pub. Date: May 13, 2021

(54) METHOD AND APPARATUS FOR PROVIDING AN ALERT REGARDING AN UNATTENDED CHILD IN A VEHICLE

(71) Applicants: Yaniv EDRI, Dimona (IL); David Rozenblat, Riverwoods, IL (US)

(72) Inventors: Yaniv EDRI, Dimona (IL); David Rozenblat, Riverwoods, IL (US)

(21) Appl. No.: 16/678,831

(22) Filed: Nov. 8, 2019

(51) Int. Cl. G08B 21/02; G06K 9/00; B60N 2/00

(52) U.S. Cl. CPC G08B 21/0277; G08B 21/0286; G08B 21/0294; B60N 2/002; G06K 9/00838

(57) ABSTRACT

An apparatus and method for providing an alert regarding an unattended child in a vehicle is provided. The apparatus includes a tethered coupling device connected with a stationary device, an untethered coupling device connected with or near a caregiver of the child, and a presence detection device for detecting the presence of a child in a seat of the vehicle. The untethered coupling device is coupled with the tethered coupling device and the presence detection device is connected with a presence detection alarm. Once the presence of a child is detected by the presence detection device and the tethered coupling device is not coupled with the untethered coupling device, the presence detection alarm is activated and generates an alert. Once the presence of a child is detected and the tethered coupling device is coupled with the untethered coupling device, the presence detection alarm is deactivated.

### BACKGROUND

Prior to the conception and development of the present invention, and as is generally well known in the prior art, parents and caregivers through forgetfulness leave young children alone in parked vehicles. This creates a health and safety risk for the child, especially if the outside temperature is particularly hot or cold. These dangers have been known to cause hypothermia, hyperthermia, dehydration or even the death of young children. Additionally, the forgetful parent or caregiver could face criminal charges for leaving a child unattended in a vehicle.

If a baby or toddler is inadvertently or purposefully left in a vehicle by a caregiver, the child can quickly be in danger of serious heat-related problems. Even if the vehicle's windows are cracked open, the vehicle is parked in the shade, and the outside temperature seems temperate to an adult, the interior temperature of the vehicle can quickly become unbearable to a child trapped therein. Tragically, some well-meaning but stressed and busy caregivers forget to remove their sleeping infant or toddler from the car and the child succumbs to the heat.

In response to this dilemma, a number of child car seat safety systems have been introduced to the prior art in an attempt to prevent such tragedy. Although such systems are adequate in their designated purpose, they still have many shortcomings. One disadvantage of many such systems is the fact that they do not provide a means that can accurately and economically notify a parent of an unattended child left in a vehicle. Additionally, many such systems also do not require that you use them and therefore may be easily defeated and therefore rendered useless. Other systems require sometime complex electronics which need to engage with complex systems within the vehicle, that may or may not work, and therefore may be unreliable. Additionally, some systems may annoy the user and lead to the user deactivating the system in order to prevent the system from sounding all the time.

Accordingly, a need remains for a child seat safety system for vehicles in order to overcome the above-noted shortcomings. The present invention satisfies such a need by providing a child seat safety system for vehicles that is easy to use, provides peace of mind to parents, and achieves increased safety and reliability for babies and toddlers. Such a system advantageously reminds a driver when a child is left unattended in a car seat when the driver is leaving or leaves a vehicle and moves out of the proximity of the child. This conveniently ensures that a tendency for busy parents to be forgetful does not result in the death of their child.

### SUMMARY

The present invention is defined by the following claims, and nothing in this section should be taken as a limitation on those claims.

In one aspect, an apparatus for providing an alert regarding an unattended child in a vehicle is provided. The apparatus includes, but is not limited to, a tethered coupling device connected with a stationary device, an untethered coupling device connected with or near a caregiver of the child, and a presence detection device for detecting the presence of a child in a seat of the vehicle. The untethered coupling device is coupled with the tethered coupling device and the presence detection device is connected with a presence detection alarm. Once the presence of a child is detected in the seat of the vehicle by the presence detection device and the tethered coupling device is not coupled with the untethered coupling device, the presence detection alarm is activated and generates an alert. Once the presence of a child is detected in the seat of the vehicle and the tethered coupling device is coupled with the untethered coupling device, the presence detection alarm is deactivated.

In another aspect, a method for providing an alert regarding an unattended child in a vehicle is provided. The method includes, but is not limited to, generating a secondary signal upon detection of a child in the seat of the vehicle by a presence detection device, and activating a presence detection alarm upon generating the secondary signal, indicating the unmonitored presence of a child in the seat of the vehicle. The method further includes deactivating the presence detection alarm upon connecting a tethered coupling device with an untethered coupling device. The tethered coupling device is connected with or near a stationary device. The stationary device is connected with or near the seat of the vehicle. The untethered coupling device is connected with or near a caregiver of the child.

In another aspect, an apparatus for providing an alert regarding an unattended child in a vehicle is provided. The apparatus includes, but is not limited to, a tethered coupling device connected with a stationary device at one end and removably coupled with a movable object at an opposing end, and a presence detection device for detecting the presence of a child in a seat of the vehicle. The presence detection device is connected with a presence detection alarm. Once the presence of a child is detected in the seat of the vehicle by the presence detection device and the tethered coupling device is not coupled with the movable object, the presence detection alarm is activated and generates an alert. Once the presence of a child is detected in the seat of the vehicle and the tethered coupling device is coupled with the movable object, the presence detection alarm is deactivated.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a general schematic view of an apparatus for providing an alert regarding an unattended child in a vehicle, in accordance with one embodiment.

FIG. 2 depicts a perspective view of an interior of a vehicle interior with an apparatus for providing an alert regarding an unattended child, in accordance with one embodiment.

FIG. 3 depicts a perspective view of a caregiver placing a child in an interior of a vehicle interior with an apparatus for providing an alert regarding an unattended child, in accordance with one embodiment.

FIG. 4 depicts an exemplary perspective view of a presence detection device of an apparatus for providing an alert regarding an unattended child in a vehicle, in accordance with one embodiment.

FIG. 5 depicts a general schematic view of an apparatus for providing an alert regarding an unattended child in a vehicle connected with a caregiver, in accordance with one embodiment.

FIG. 6 depicts a perspective view of an interior of a vehicle interior with a caregiver and an apparatus for providing an alert regarding an unattended child in a vehicle connected with a caregiver's smartphone, in accordance with one embodiment.

FIGS. 7A, 7B, and 7C depict a schematic diagram of an electrical circuit of an apparatus for providing an alert regarding an unattended child in a vehicle, in accordance with one embodiment.

FIGS. 7D, 7E, and 7F depict a schematic diagram of an electrical circuit of an apparatus for providing an alert regarding an unattended child in a vehicle, in accordance with one embodiment.

FIG. 8 depicts a perspective view of an interior of a vehicle interior with a caregiver exiting the vehicle and an apparatus for providing an alert regarding an unattended child in a vehicle, in accordance with one embodiment.

FIG. 9 depicts a flowchart of a method for providing an alert regarding an unattended child in a vehicle, in accordance with one embodiment.

FIG. 10 depicts a general schematic view of an apparatus for providing an alert regarding an unattended child in a vehicle, in accordance with one embodiment.

FIG. 11 depicts a perspective view of an interior of a vehicle interior with an apparatus for providing an alert regarding an unattended child, in accordance with one embodiment.

FIG. 12 depicts a block schematic diagram of an exemplary computing system, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

Prior to proceeding to the more detailed description of the present invention it should be noted that, for the sake of clarity and understanding, identical components which have identical functions have been identified with identical reference numerals throughout the several views illustrated in the drawing figures.

With reference to FIG. 12, depicted is an exemplary computing system 100 for implementing embodiments. In one embodiment, the computing system 100, or portions of it, may be found within electrical circuit 60, described herein, however, in another embodiment the electrical circuit 60 does not have all or any aspects of the computing system 100, but is rather a simplified electrical circuit with no intelligence or software control. FIG. 12 includes a computer 110, which could be any one of a remote computer or device or local computer or device. Computer 110 may be a portable device, wherein at least some or all of its components are formed together in a single device which can be carried around by a person. The computer 110 includes a processor 111, memory 120 and one or more drives 130. The drives 130 and their associated computer storage media provide storage of computer readable instructions, data structures, program modules and other data for the computer 110. Drives 130 can include an operating system 140, application programs 150, program modules 160, and program data 180. Computer 110 further includes input devices 190 through which data or signals may enter the computer 110, either automatically or by a user who enters commands and data. Input devices 190 can include: an electronic digitizer; a microphone; an optical camera; a keyboard; a mechanical switch; a sensor such as a pressure sensor, and weight sensor, an optical sensor, an electro-optical sensor, and a vibration sensor; an electro-mechanical switch; an electrical switch; and a pointing device, commonly referred to as a mouse, trackball or touch pad. Other input devices 190 may include a joystick, game pad, satellite dish, scanner, and the like. In one or more embodiments, input devices 190 are portable devices that can direct display or instantiation of applications running on processor 111.

These and other input devices 190 can be connected to processor 111 through a user input interface that is coupled to a system bus 192, but may be connected by other interface and bus structures, such as a parallel port, game port or a universal serial bus (USB). Computers such as computer 110 may also include other peripheral output devices such as speakers and/or display devices, which may be connected through an output peripheral interface 194 and the like.

Preferably, computer 110 includes a radio 198 for wirelessly transmitting and receiving data for the computer 110 with the aid of an antenna. Radio 198 may wirelessly transmit and receive data using WiMAX′, 802.11a/b/g/n, Bluetooth™, 2G, 2.5G, 3G, and 4G, wireless standards.

Computer 110 may operate in a networking environment 199 using logical connections to one or more remote computers, such as a remote computer 185. The remote computer 185 may be a smartphone, a personal computer, a server, a router, a network PC, a peer device or other common network node, and may include many if not all of the elements described above relative to computer 110. Networking environments 199 are commonplace in offices, enterprise-wide computer networks, intranets and the Internet. For example, in the subject matter of the present application, computer 110 may comprise a source machine from which data is being migrated, and the remote computer 185 may comprise a destination machine. Note, however, that source and destination machines need not be connected by networking environment 199 or any other means, but instead, data may be migrated via any media capable of being written by the source platform and read by the destination platform or platforms. When used in a LAN or WLAN networking environment 199, computer 110 is connected to the LAN through a network interface 196 or an adapter. When used in a WAN networking environment 199, computer 110 may include a modem or other means for establishing communications over the WAN to environments such as the Internet. It will be appreciated that other means of establishing a communications link between computers 110 and other computers, such as remote computer 185, may be used. According to one embodiment, computer 110 is connected in a networking environment 199 such that processor 111 can process incoming and outgoing data.

With reference to FIG. 1 and FIG. 2, a general schematic view of one embodiment of a child monitoring apparatus 10 for providing an alert 54 regarding an unattended child 12 in a vehicle 14 is provided. The alert 54 is any type of signal or message that can provide notice to a caregiver 24 of an event, such as that the child 12 is still in the vehicle 14. Vehicle 14 is any device or machine for transporting people or goods that the child 12 may occupy, and includes vehicles such as an automobile, a van, a bus, a train, an airplane, and a boat.

Child monitoring apparatus 10 includes a tethered coupling device 20, an untethered coupling device 30, and a presence detection device 50. The tethered coupling device 20 is connected with a stationary device 22 on or within the vehicle 14.

Preferably, the stationary device 22 is connected with or near the child 12 or a portion of a car in which the child 12 is situated. In one embodiment, the stationary device 22 is connected with or is attached to or is a seat 16 in which the child 12 is seated, such as a child safety seat 18. A child safety seat 18 is a seat that is designed specifically to protect children from injury or death during vehicle collisions, and is commonly referred to as a child seat. In another embodiment, the stationary device 22 is located at or near the caregiver 24. In one embodiment, the stationary device 22 is one of any seat 16 of the vehicle 14, a portion of a vehicle 14 in which the seat 16 of the vehicle is situated, a seat belt, a seat belt buckle, a console, a dashboard, a door, a seat, or any portion or part of the interior or exterior of the vehicle 14. The stationary device 22 may be moved with respect to the vehicle 14, for example, if the stationary device 22 were a seat belt buckle that moves from one part of the vehicle 14 to another. However, preferably, the stationary device 22 is connected with a part or portion of the vehicle 14, either directly or indirectly, and remains connected with the vehicle 14 when the child monitoring apparatus 10 is in use. With reference to FIG. 6, in one embodiment the stationary device 22 is a seat belt buckle. With reference to FIG. 2, the stationary device 22 is a child safety seat 18.

The untethered coupling device 30 is connected with or near a caregiver 24 of the child 12. With reference to FIG. 1, in one embodiment, the untethered coupling device 30 includes a clip 31 to help it be connected with or near a caregiver 24. In one embodiment, the untethered coupling device 30 is connected with one of: the caregiver 24; an item of clothing on the caregiver 24, such as a dress, a shirt, pants, a belt, a purse, or wallet of the caregiver 24; or item within the vehicle 14, such as a seat 16 or seat belt or a removable portion of the child safety seat 18. In one embodiment, the untethered coupling device 30 is an electronic device of the caregiver 24, such as a watch, a smart watch, a smartphone, or a portable computer. In one embodiment, the untethered coupling device 30 is a smartphone which is electronically coupled with the tethered coupling device 20, as shown in FIG. 6.

In one embodiment, the untethered coupling device 30 includes an electronic device with communication circuitry which can send and/or transmit an electronic signal, and preferably, which can send and receive a wireless electronic signal using a wireless communication device, such as WiFi, Bluetooth, Cellular, or any other form of radio communications. If the untethered coupling device 30 sends and/or transmit a wireless electronic signal, that signal can then be picked up by the tethered coupling device 20 and be used to determine whether or not the untethered coupling device 30 is in close proximity to or connected with the tethered coupling device 20, and therefore connected with the tethered coupling device 20.

In one embodiment, the untethered coupling device 30 is connected with, and preferably removably connected with, the tethered coupling device 20, either physically, or virtually when in close proximity. In one embodiment, the coupling devices 20 and 30 are physically connected with each other, either mechanically, magnetically, or chemically coupled together. With Reference to FIG. 5, in one embodiment, the untethered coupling device 30 is mechanically coupled with the tethered coupling device 20 via a pair of interlocking complimentary engagement members 34, 35. Preferably, the coupling devices 20 and 30 may be mechanically coupled together wherein the tethered coupling device 20 has a primary complimentary engagement member 34 which may be removably connected with a second complimentary engagement member 35 of the untethered coupling device 30. Preferably, the complimentary engagement members 34, 35 are one of: a structural engagement, whereby the housing or structure of each coupling device 20, 30 are physically designed to removably engage with and/or mate with each other, as shown in FIG. 5; a mechanical fastener; a magnetic fastener, such as a pair of opposing magnets; a hook and loop type fastener, such as Velcro; and a chemical fastener, such as glue or silicone; and a suction device.

In one embodiment, the untethered coupling device 30 is electronically coupled with the tethered coupling device 20 via an electrical connection which forms when the two coupling devices 20, 30 are in close proximity or actually in contact. For example, with reference to FIG. 1, in one embodiment, each coupling device 20, 30 includes an electrical contact 36, 37, respectively, wherein when the first contact 36 comes into physical and/or electrical contact with the second contact 37, an electrical circuit is either completed/closed or opened, causing a signal to be generated or to be prevented from being generated, and resulting in the presence detection alarm 52 to generate an alert 54, or not generate an alert 54.

With reference to FIGS. 7A, 7B, 7C, in one embodiment, one example of an electrical circuit 60 for providing an alert regarding an unattended child 12 in a vehicle 14 is shown. In this embodiment, a power source 61 is provided, such as a battery, and the presence detection device 50 is connected between the power source 61 and a presence detection alarm 52, such as a speaker. With reference to FIG. 7A, initially, the electrical circuit 60 is in an open state, wherein the presence detection device 50 does not detect the presence of a child 12, and current does not flow from the presence detection device 50 to the presence detection alarm 52 to activate the presence detection alarm 52. In one embodiment, the presence detection device 50 includes a switch 56 which is initially in an open state, until the presence detection device 50 detects the presence of a child 12, wherein the switch is closed and power is supplied from the presence detection device 50 to the presence detection alarm 52 to generate an alert 54. Then, with reference to FIG. 7B, when the presence detection device 50 detects the presence of a child 12, current will flow from the presence detection device 50 to the presence detection alarm 52, to activate the alarm 52 and generate an alert 54. Preferably, the switch 56 is moved to a closed state when the presence detection device 50 detects the presence of a child 12, wherein the switch 56 is closed and power is supplied from the presence detection device 50 to the presence detection alarm 52 to generate an alert 54. With reference to FIG. 7C, the alert 54 will continue to be generated until the tethered coupling device 20 is brought near or in contact with the untethered coupling device 30, and a second switch 49, which is biased to a closed position, is opened when brought near or in contact with the untethered coupling device 30. The switch 49 may be opened or closed when brought near the untethered coupling device 30 either mechanically, magnetically or electrically. For example, in one embodiment, the untethered coupling device 30 includes a magnet 58 which moves the switch 49 to an open position, and causes the circuit 60 to open an deactivates the presence detection alarm 52.

However, the reverse may be true as well, and additionally, an infinite number of circuits 60 may be designed to function in a same or similar manner. For example, with reference to FIGS. 7D, 7E, 7F, in one embodiment, another example of an electrical circuit 60′ for providing an alert regarding an unattended child 12 in a vehicle 14 is shown. In this embodiment, a power source 61 is provided, such as a battery, and the presence detection device 50 is connected between the power source 61 and a presence detection alarm 52, such as a speaker. With reference to FIG. 7D, initially, the electrical circuit 60′ is in an open state, wherein the presence detection device 50 does not detect the presence of a child 12, and current does not flow from the presence detection device 50 to the presence detection alarm 52 to activate the presence detection alarm 52. In one embodiment, the presence detection device 50 includes a switch 56 which is initially in an open state, until the presence detection device 50 detects the presence of a child 12, wherein the switch 56 is closed and power is supplied from the presence detection device 50 to the presence detection alarm 52 to generate an alert 54. Then, with reference to FIG. 7E, when the presence detection device 50 detects the presence of a child 12, current will flow from the presence detection device 50 to the presence detection alarm 52, to activate the alarm 52 and generate an alert 54. Preferably, the switch 56 is moved to a closed state when the presence detection device 50 detects the presence of a child 12, wherein the switch is closed and power is supplied from the presence detection device 50 to the presence detection alarm 52 to generate an alert 54. With reference to FIG. 7F, the alert 54 will continue to be generated until the tethered coupling device 20 is brought near or in contact with the untethered coupling device 30, and a second switch 49, which is biased to a closed position, is opened when brought near or in contact with the untethered coupling device 30. The switch 49 may be opened or closed when brought near the untethered coupling device 30 either mechanically, magnetically or electrically. For example, in one embodiment, the circuit 60′ includes a magnet 58 which moves the switch 49 to an open position, and causes the circuit 60 to open an deactivates the presence detection alarm 52. In one embodiment, the switch 49 is in the untethered coupling device 30, as shown in FIGS. 7A, 7B, and 7C, and in one embodiment, the switch 49 is external to the untethered coupling device 30, as shown in FIGS. 7D, 7E, and 7F. In one embodiment, the magnet 58 is in the untethered coupling device 30, as shown in FIGS. 7A, 7B, and 7C, and in one embodiment, the magnet 58 is external to the untethered coupling device 30, as shown in FIGS. 7D, 7E, and 7F.

As one of ordinary skill in the art is aware, there are a limitless number of circuits which can be designed that allow for the presence detection alarm 52 to emit an alert 54 when the presence detection device 50 detects the presence of a child 12 and the tethered coupling device 20 is not near or couple with the untethered coupling device 30, and to stop emitting an alert 54 either: 1) when the presence detection device 50 does not detect the presence of a child 12; or 2) when the presence detection device 50 detects the presence of a child 12 and the tethered coupling device 20 is near or coupled with the untethered coupling device 30. The electrical circuit 60, 60′ shown in FIGS. 7A, 7B, 7C, 7D, 7E, & 7F are just two types of circuits that can perform such tasks.

In one embodiment, the untethered coupling device 30 is virtually coupled with the tethered coupling device 20 via a wireless electrical connection which forms when the two coupling devices 20, 30 are in close proximity. In this embodiment, each coupling device 20, 30 includes at least one of a transmitter, a receiver, and/or a transceiver which send/receive wireless radio signals. With reference to FIG. 6, in one embodiment, the untethered coupling device 30, preferably a smartphone 32, includes a transmitter which transmits wireless radio signals which are received by a receiver on the tethered coupling device 20, and which serve to virtually couple the two devices 20, 30 together. When the transmitted radio signals are no longer received by the tethered coupling device 20, or are received but with a signal strength less than a predetermined amount, then the two devices 20, 30 would no longer be considered connected or coupled together.

In one embodiment, one of the untethered coupling device 30 and the tethered coupling device 20 would generate a coupling signal 68 when the devices 20, 30 were brought into close proximity of each other or moved away from each other. Preferably, depending on the strength of the coupling signal 68 received, or if a coupling signal 68 was received at all, one of the devices 20, 30 would then generate and transmit a primary signal 64 to the electrical circuit 60 which would then either activate or deactivate the presence detection alarm 52, preferably based upon the strength of the coupling signal 68 received by the opposing device 20, 30 that did not generate the coupling signal 68. In one embodiment, with reference to FIG. 6, the presence detection alarm 52 may be coupled with or integral with the untethered coupling device 30, so that the caregiver may more clearly or easily receive the alert 54.

In one embodiment, the coupling device 20 or 30 that is not generating the coupling signal 68 would either receive or not receive a coupling signal 68, and based upon the strength of this signal 68, the electrical circuit 60 would then either activate or deactivate the presence detection alarm 52. For example, in one embodiment, a coupling signal 68 would be generated by one coupling device 20 or 30 and received by the opposing coupling device 30 or 20 and based upon the strength of the signal 68 received, or based upon receiving the signal at all, the presence detection alarm 52 would either generate an alert 54 or not generate an alert 54. In one embodiment, the coupling devices 20 and 30 can be electrically connected via a physical electrical contact, via magnetic induction, or some other type of physical electrical connection, so that a signal can be transmitted from one coupling device 20 or 30 to an opposing coupling device 30 or 20, to indicate that the two coupling devices 20 and 30 are near each other or coupled with each other.

The presence detection device 50 is for detecting the presence of a child 12 in a seat 16 of the vehicle 14. The present detection device 50 is any device or sensor which is capable of detecting the presence of a body, such as a child 12. Preferably, the presence detection device 50 is one of a mechanical switch, an electro-mechanical switch, an electrical switch, a pressure sensor, and weight sensor, an optical sensor, and electro-optical sensor, a vibration sensor, and an optical camera 48. Preferably, the presence detection device 50 generates a secondary signal 66 once the presence of a child 12 in the seat 16 or 18 is detected. Preferably, the secondary signal 66 is generated when there is the detection and presence of a human or child 12 in the seat 16 or 18. However, the presence detection device 50 can be configured so that the secondary signal 66 is generated when there is no detection or no presence of a human or child 12 in the seat 16 or 18.

With reference to FIG. 4, in one embodiment, the presence detection device 50 is a switch or pressure pad which includes a first plate and electrical contact 51 separated by a distance, preferably via a spring 55, from a second plate and electrical contact 53, so that when pressure is placed on the first plate and electrical contact 51, it comes into contact with the second plate and electrical contact 53, and preferably the first contact 51 comes into contact with the second contact 53, such that a circuit is completed and an electrical signal is generated, such as the secondary signal 66 indicating the presence of a child 12. With reference to FIG. 3, if the presence detection device 50 is a switch or pressure pad, preferably the presence detection device 50 is placed at or under a seat cushion of the child safety seat 18 so that every time the child 12 sits on the child safety seat 18, the electrical circuit 60 of the presence detection device 50 is completed and an electrical signal is generated, such as the secondary signal 66 indicating the presence of a child 12.

In one embodiment, once the presence of a child 14 is detected in the seat 16 or 18 in the vehicle 14 by the presence detection device 50 and the tethered and untethered coupling devices 20, 30 are not connected, a secondary signal 66 is either generated and transmitted to or prevented from being generated and transmitted to the presence detection alarm 52, causing the presence detection alarm 52 to be activated and to preferably generate an alert 54. In this application and its claims, the term “to generate” may also be used synonymously with the term “to not generate,” as the generation of a primary or secondary signal 64, 66 or the lack of generation of a primary or secondary signal 64, 66 can be seen to represent the same thing. For example, in one embodiment, the generation of a secondary signal 66 may represent the presence of a child 12 in the seat 18, however, in another embodiment, the lack of generation of a secondary signal 66 may be seen to represent the presence of a child 12 in the seat 18 as well. Therefore, both techniques can be used to indicate the presence or lack thereof, of the child 12 in seat 18.

In one embodiment, the presence detection device 50 includes an optical sensor, such as a laser, which is situated on or in the child safety seat 18, and which generates a light or laser beam which is broken or interfered with once the child 12 is seated with the child safety seat 18. Preferably, once light or laser beam which is broken or interfered with, the presence detection device 50 generates a secondary signal 66 indicating that the detection of a human or child 12.

In one embodiment, the presence detection device 50 includes a weight sensor which detect the presence or absence of a body, such as a child 12. In this embodiment, when the child 12 is placed in the seat 16, or more specifically, the child safety seat 18, the pressure sensor, which could be placed in a pad underneath where the child 12 sits. Preferably, once the weight of a child 12 is detected or beyond a set point, the presence detection device 50 generates a secondary signal 66 indicating that the detection of a human or child 12.

With reference to FIG. 6, in one embodiment, the presence detection device 50 includes an optical camera 48 connected with a computer running image detection algorithms which can detect the presence of a child 12. Preferably, the camera 48 is aimed at the seat 16, and preferably the child safety seat 18. Preferably, once the camera 48 detects the presence of a child 12, the presence detection device 50 generates a secondary signal 66 indicating that the detection of a human or child 12.

In one embodiment, with reference to FIG. 4, the presence detection device 50 includes a pair of electronic contacts 51, 53 spaced apart located at or under a seat cushion of the seat 16 or the child safety seat 18 in the vehicle 14, whereby when a child 12 sits on the seat cushion, the electronic contacts 51, 53 are connected and the presence detection device 50 generates a secondary signal 66.

In one embodiment, the presence detection device 50 is positioned at or near the seat 16 or 18 in the vehicle 14, so as to be able to determine the presence or absence of a child 12 in the seat 16 or 18.

Preferably, the presence detection device 50 is in communication with or connected with a presence detection alarm 52. The presence detection alarm 52 is activated based upon the receipt of or absence of a combination of all or one of the primary and secondary signals 64, 66, and depends on what the primary and secondary signals 64, 66 are generated for. For example, the primary signal 64 can be generated when the untethered coupling device and the tethered coupling device are either brought into close proximity of each other or moved away from each other or are not in close proximity of each other. Similarly, the secondary signal 66 can be generated when the presence of a child 12 is detected in the seat 16 or 18, or the absence of a child 12 is detected in the seat 16 or 18. Preferably, in one embodiment, the presence detection alarm 52 activates when the presence of a child 12 is detected in the seat 16 or 18 and the untethered coupling device 30 and the tethered coupling device 20 are not in close proximity of each other. Preferably, to be in close proximity of each other, the untethered coupling device 30 and the tethered coupling device 20 are within 1000 meters of each other, and preferably, 500 meters, and preferably, 50 meters, and preferably, 10 meters, and more preferably, 1 meter, and most preferably 0.5 meters, and most preferably 0.3 meters, and most preferably are less than 0.1 meters.

In one embodiment, a primary signal 64 is generated when the untethered coupling device 30 and the tethered coupling device 20 are in close proximity of each other, and a secondary signal 66 is generated by the presence detection device 50 when a child 12 is in the seat 16 or 18. However, the reverse can be true as well, and a primary signal 64 can be generated when the untethered coupling device 30 and the tethered coupling device 20 are in not close proximity of each other, and a secondary signal 66 can be generated by the presence detection device 50 when a child 12 is not in the seat 16 or 18. So when the electrical circuit 60 is constructed or programmed, the generation or the absence of generation of a primary signal 64 can represent either that the untethered coupling device 30 and the tethered coupling device 20 are or are not in not close proximity of each other. Additionally, the generation or the absence of generation of a secondary signal 64 can represent either that the presence of a child 12 has or has not been detected in the child safety seat 18.

In one embodiment, the primary and secondary signals 64, 66 are transmitted to electrical circuit 60 which then activates or deactivates the presence detection alarm 52 based upon the receipt of or absence of a combination of all or one of the primary and secondary signal 64, 66. The electrical circuit 60 can be a simple electrical circuit which is connected with the presence detection alarm 52 and provided power to the presence detection alarm 52 only when certain signals are received or not received. In this embodiment, the circuit 60 can be closed or opened depending on whether or not the coupling devices 20, 30 are in close proximity of each other or not, and depending on whether or not when the presence of a child 12 is detected in the seat 16 or 18 or not.

In one embodiment, the circuit 60 is closed when the presence of a child 12 is detected in the seat 16 or 18 and the coupling devices 20, 30 are not in close proximity of each other, causing the presence detection alarm 52 to activate. In this embodiment, the circuit 60 is opened when the presence of a child 12 is detected in the seat 16 or 18 and the coupling devices 20, 30 are in close proximity of each other, or when the presence of a child 12 is not detected in the seat 16 or 18, causing the presence detection alarm 52 to become deactivated. However, these conditions can be reversed if desired. Preferably, the electrical circuit 60 causes the presence detection alarm 52 to activate when the presence of a child 12 is detected in the seat 16 or 18 and the coupling devices 20, 30 are not in close proximity of each other.

In one embodiment, the electrical circuit 60 includes a more complex circuit with a computer 110 or portions of the computer 110, such as a processor 111 and memory 120 and logic or software running on the processor 111 which decide when the appropriate conditions are met to activate or deactivate the presence detection alarm 52. The electrical circuit 60 can be electrically connected to the presence detection device 50, the presence detection alarm 52 and the coupling devices 20, 30, either directly via electrical signals that travel along physical wiring, or indirectly using wireless radio signals, or a combination of both direct and indirect means using both wired and wireless signals. Additionally, the electrical circuit 60 can reside near or on the child safety seat 18, within the presence detection device 50, the presence detection alarm 52, the tethered coupling device 20, the untethered coupling device 30, or remotely in a portable electronic device such as a smartphone 32.

In one embodiment, the tethered coupling device 20 is virtually connected with the presence detection device 50 via a wireless electrical connection or is electrically connected via a physical, wired electrical connection. In one embodiment, the electrical circuit 60, the presence detection device 50, the presence detection alarm 52, and the coupling devices 20, 30, are electrically connected either directly via electrical signals that travel along physical wiring, or indirectly/virtually using wireless radio signals, or a combination of both direct and indirect means using both wired and wireless signals.

In one embodiment, the presence detection device 50 is directly electrically connected with the presence detection alarm 52 via physical wiring. In one embodiment, the presence detection device 50 is wirelessly connected with the presence detection alarm 52. In one embodiment, the presence detection alarm is located within smartphone 32 and activated via an application or app running on the smartphone 32.

Preferably, once the presence of a child 12 is detected in the seat 16 or 18 of the vehicle 14 by the presence detection device 50 and the tethered coupling device 20 is not coupled with the untethered coupling device 30, the presence detection alarm 52 is activated and generates an alert 54. The alert 54 is any type of signal or message that can provide notice to a caregiver 24 of an event, such as that the child 12 is still in the vehicle 14. Preferably, the presence detection alarm 52 is located in the vehicle 14, and preferably at or around the seat 16 or 18 or at or around the caregiver 24. In one embodiment, the presence detection alarm 52 is located on a portable electronic device, such as a smartphone.

Preferably, the alert 54 is at least one of an audible, visual, or vibratory alert, or any other type of method that would activate sensory stimulus in a human. In one embodiment, the alert 54 is a message that appears on a display, such as a display of a smartphone. Preferably, the message is one of an SMS message, an email message, an smartphone alert message on the display of the smartphone. In one embodiment, in addition to simply being a message that appears on a display, an additional alert, such as a sound or vibration is emitted, preferably from the smartphone to further notice to a caregiver 24 of an event. In one embodiment, the alert 54 is generated by the vehicle 14 or by something connected with the vehicle 14, such as a vehicle alarm or horn of the vehicle. For example, in one embodiment, the alert 54 is generated by flashing headlights of the vehicle 14 and/or activating the horn of the vehicle 14. In one embodiment, the alert 54 is generated by a device connected with the presence detection alarm 52, such as a speaker, a light, or a vibration creating mechanism.

Preferably, once the presence of a child 12 is detected in the seat 16 or 18 of the vehicle 14 by the presence detection device 50 and the tethered coupling device 20 is coupled with the untethered coupling device 30, the presence detection alarm 52 is deactivated and the alert 54 is stopped, or a further alert is generated indicating that the child 12 is currently in close proximity to or being attended to by the caregiver 24.

With reference to FIG. 5, in one embodiment, the child monitoring apparatus 10 further comprises a physical tether 70 connected with the tethered coupling device 20 at a first end. The tether 70 serves to anchor and connect the tethered coupling device 20 to seat 16, the child safety seat 18, or any part of the vehicle 14. In one embodiment, the tether 70 is connected with the tethered coupling device 20 and anchored at a second end opposed to the first end. Preferably, the tether 70 is anchored to the child safety seat 18, however, the tether 70 may be anchored to any seat 16 within the vehicle 14, to a seat belt or seat belt buckle within the vehicle 14, such as the caregiver 24's seat belt buckle. In this manner, by attaching one end of the tether 70 to a part of the vehicle 14, the location of the tether 70 and the tethered coupling device 20 can be established.

With reference to FIG. 5, in one embodiment, the tethered coupling device 20 is electrically connected with the second end of the tether 70, and preferably the second end of the tether 70 is electrically connected to the presence detection devices 50 and/or the electrical circuit 60, via a wired electrical connection 72 allowing for electrical signals to be transmitted from the tethered coupling device 20 to the presence detection devices 50 and/or the electrical circuit 60. In this manner, the tethered coupling device 20 can be reliably and effectively physically connected with the electrical circuit 60. This physical connection provides a reliable and accurate way to transmit the primary signal 64 from the coupled devices 20, 30 to the electrical circuit 60. Additionally, with reference to FIG. 1 and FIG. 2, the tether 70 can be removably secured to the child safety seat 18, preferably via a post 23 affixed to the seat 18, in order to restrict the location of the tethered coupling device 20 to be near or at the location of the seat 16 or 18 in which the child 12 will be seated. By using a physical tether 70, the location of the tethered coupling device 20 can be physically restricted, instead of virtually restricted as with a wirelessly tethered coupling device 20, as shown in FIG. 6 which, and therefore the location of the tethered coupling device 20 may be even more reliable than a wirelessly connected coupling device 20.

With reference to FIG. 6, in one embodiment, the tethered coupling device 20 is coupled to another item within the vehicle 14, such as a seat belt 26, preferably using a fastener such as a clip 25. By coupling the tethered coupling device 20 to a seat belt 26 with a clip 25, the location of the tethered coupling device 20 is relatively fixed with relation to the child safety seat 18. Furthermore, since the seat belt 26 is actively moved from an open and unsecured position, to a closed and secure position whereby the occupant of the care is secured in their seat by the seat belt 26, the tethered coupling device 20, which is coupled to the seat belt 26, would also move and as a result would likely move closer to the caregiver 24 when the caregiver 24 is occupying the vehicle 14, and away from the caregiver 24 as the caregiver 24 is exiting the vehicle 14, causing the presence detection alarm 52 to activate if the presence of a child 12 is still detected in the seat 18, alerting the caregiver to the fact that a child 12 is still in the seat 18.

Preferably the tethered coupling device 20 is coupled with or connected to some part within the vehicle 14 or the vehicle 14 itself, and preferably the untethered coupling device 30 is connected with the caregiver 24, or with something in contact with or carried by the caregiver 24, so that every time the caregiver 24 leaves the vehicle 14, the untethered coupling device 30 becomes uncoupled from or disconnected from the tethered coupling device 20.

With reference to FIG. 1 and FIG. 2, the tether 70 may include a clip 27 at one end, preferably opposed to the end that the tethered coupling device 20 is affixed, wherein the clip 27 engages with and is removably connected with the child safety seat 18, and preferably a post 23 connected with the child safety seat 18.

With reference to FIG. 9, a method 200 for providing an alert regarding an unattended child 12 in a vehicle 14 is provided. The method starts at step 201, and then once started moves to step 202 and begins to determine whether or not the presence of a child 12 is detected within the vehicle 14, and preferably within the child safety seat 18, preferably using the presence detection device 50. If the presence of a child 12 is detected in the vehicle 14, and preferably in the child safety seat 18 of the vehicle 14, a secondary signal 66 is generated upon detection of a child 12 in the seat 18 of the vehicle 14 by the presence detection device 50 at step 204.

Moving to step 206, the method 200 also begins to determine whether or not the untethered coupling device 30 is connected to, that is either coupled with or near, the tethered coupling device 20. If the untethered coupling device 30 is connected to the tethered coupling device 20, then a primary signal 64 is generated by the child monitoring apparatus 10, and preferably one of the coupling devices 20 or 30.

Moving to step 210, the method 200 then determines what signals 64, 66 are being generated or not. Preferably, the method 200 activates a presence detection alarm 52 upon generating the secondary signal 66 at step 212, indicating the unmonitored presence of a child 12 in the seat of the vehicle 14, if only the secondary signal 66 is detected and not the primary signal 64. However, if both the primary and secondary signals 64, 66 are generated and detected, the method 200 then moves to step 214 and deactivates the presence detection alarm 52 upon detecting both the primary and secondary signals 64, 66. Preferably, once the secondary signal is generated at step 204, or the presence of a child 12 is detected in the vehicle 14, the alarm 52 is deactivated only upon connecting the tethered coupling device 20 with an untethered coupling device 30. Preferably, the tethered coupling device 20 is connected with or near a stationary device 22, and preferably the stationary device 22 is connected with or near the seat 16 of the vehicle 14, and the untethered coupling device 30 is connected with or near a caregiver 24 of the child 12.

In one embodiment, the presence detection alarm 52 is reactivated upon disconnecting, decoupling, or moving the tethered coupling device 20 away from the untethered coupling device 30.

With reference to FIGS. 10 and 11, in one embodiment, the tethered coupling device 20 is connected with a stationary device 22 at one end 88 and removably coupled with a movable object 90 at an opposing end 89. Preferably, the movable object 90 is an object that is not fixed in relation to the stationary device 22. Preferably, the movable object 90 is an object that either moves within the vehicle 14 or moves in and out of the vehicle 14, and preferably does this movement at a time when the caregiver 24 is exiting or entering the vehicle 14. In one embodiment, the moveable object 90 is one of a caregiver, an item of clothing worn by the caregiver, or an item within the vehicle. Preferably, the movable object 90 is one of a pocket, a dress, a shirt, pants, a belt, a purse, a wallet, a seat belt, and a removable portion of a seat 16 or child safety seat 18, or some other device or object which might be removed from the vehicle 14 preferably upon exiting the vehicle 14. For example, some child safety seats 18 have removable portions in which the child 12 resides so that the child can be moved in and out of the vehicle 14 without having to unbuckle the child from the child safety seat 18.

In this embodiment, once the presence of a child 12 is detected in the seat 16, 18 of the vehicle 14 by the presence detection device 50 and the tethered coupling device 20 is not coupled with the movable object 90, the presence detection alarm 52 is activated and generates an alert 54. Then, once the presence of a child 12 is detected in the seat 16, 18 of the vehicle 14 and the tethered coupling device 20 is coupled with the movable object 90, the presence detection alarm 52 is deactivated. Preferably, the movable object 90 is connected with the caregiver 24, so when the caregiver 24 leaves the vehicle 14, the tethered coupling device 20 becomes uncoupled from the movable object 90, and the presence detection alarm 52 is reactivated, alerting the caregiver 24 to the fact that the child 12 is still present in the seat 16, 18 of the vehicle 14.

In one embodiment, the tethered coupling device 20 includes a clip 75, having first and second movable portions 76, 77. Preferably, the movable portions 76, 77 are biased together in a normal state and have first ends 73, 74, respectively, which can be opened or moved apart when second ends 81, 82, respectively, are pressed and brought together. Preferably, the clip 75 includes a spring 80 which biases the first ends 73, 74 together and the second ends 81, 82 apart, wherein the second ends 81, 82 are opposed to the first ends 73, 74. When the second ends 81, 82 are pressed together, spring 80 is compressed, causing the first ends 73, 74 to be pushed away from each other, as shown in FIG. 11. Preferably, a pair of sensors or contacts 73, 74 are at each end 73, 74, so that electrical circuit 60 can sense or know when the ends 73, 74 are together or apart.

In this embodiment, once the presence of a child 12 is detected in the seat 16 of the vehicle 14 by the presence detection device 50 and the tethered coupling device 20 is not clipped to an object, that is when the first ends 73, 74 are together or touching, the presence detection alarm 52 is activated and generates an alert 54. In this embodiment, once the presence of a child 12 is detected in the seat 16 of the vehicle 14, the tethered coupling device 20 must be clipped with an object in order for the presence detection alarm 52 to be deactivated. That is, once the presence of a child 12 is detected in the seat 16 of the vehicle 14, the first ends 73, 74 of the clip 75 must be moved apart from each other or not touching in order for the presence detection alarm 52 to be deactivated. Preferably, this results in the tethered coupling device being clipped to an object. Preferably, the object is on or about the caregiver 24, and includes the caregiver 24 or any part of the caregiver 24; an item of clothing on the caregiver 24, such as a dress, a shirt, pants, a belt, a purse, or wallet of the caregiver 24; or item within the vehicle 14 near the caregiver, such as a seat 16 or seat belt. Preferably, the object is movable and preferably, the object leaves the vehicle 14 or moves within the vehicle 14 at or around the same time as the caregiver 24 exits the vehicle 14.

In the foregoing specification, specific embodiments have been described. However, one of ordinary skill in the art appreciates that various modifications and changes can be made without departing from either the spirit of the invention or the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An apparatus for providing an alert regarding an unattended child in a vehicle comprising:
a tethered coupling device connected with a stationary device through a tether, wherein the tether has a first end connected with the tethered coupling device and a second end connected with the stationary device,
an untethered coupling device connected with a caregiver of the child, and
a presence detection device for detecting a presence of the child in a seat of the vehicle, wherein the presence detection device is connected with a presence detection alarm,
wherein the tethered coupling device is not physically connected with the untethered coupling device before the presence of a child is detected,
wherein upon the child being placed in the seat by the caregiver, the presence of the child is detected in the seat of the vehicle by the presence detection device, and the presence detection alarm is activated and generates an alert, and
wherein once the presence of a child is detected in the seat of the vehicle and the presence detection alarm is activated, the caregiver brings into contact the second end of the tethered coupling device with the untethered coupling device, and the presence detection alarm is deactivated.

2. The apparatus of claim 1, wherein the seat is a child safety seat.

3. The apparatus of claim 1, further comprising a tether having first and second opposing ends, wherein the tethered coupling device is connected with the first end, and wherein the second end is connected with the stationary device.

4. The apparatus of claim 1, wherein the tethered coupling device is electrically connected with the presence detection device via either a wireless electrical connection, or a wired electrical connection.

5. The apparatus of claim 3, wherein the second end of the tether is electrically connected to the presence detection device via a wired electrical connection.

6. The apparatus of claim 1, wherein the stationary device is connected with the child or a portion of a vehicle in which the child is situated.

7. The apparatus of claim 1, wherein the stationary device is one of a seat of the vehicle, a portion of a vehicle in which the seat of the vehicle is situated, a seat belt, a seat belt buckle, a console, a dashboard, a door, a seat, or any portion or part of the interior or exterior of the vehicle.

8. The apparatus of claim 1, wherein the untethered coupling device is mechanically, magnetically, or electronically coupled with the tethered coupling device.

9. The apparatus of claim 8, wherein the untethered coupling device is electronically coupled with the tethered coupling device via a wireless connection.

10. The apparatus of claim 9, wherein the untethered coupling device or the tethered coupling device generated a primary signal when either brought into close proximity of each other or moved away from each other.

11. The apparatus of claim 8, wherein the untethered coupling device is mechanically coupled with the tethered coupling device via a pair of complimentary engagement members.

12. The apparatus of claim 11, wherein each complimentary mechanical coupling device includes one of a mechanical fastener, a magnetic fastener, a hook and loop type fastener, and a chemical fastener such as glue or silicone.

13. The apparatus of claim 1, wherein a first electrical circuit is closed or opened when the untethered coupling device is coupled with the tethered coupling device.

14. The apparatus of claim 13, wherein once the presence of the child is detected in the seat of the vehicle by the presence detection device and the tethered and untethered coupling devices are not connected, a secondary signal is either generated and transmitted to or prevented from being generated and transmitted to the presence detection alarm, causing the presence detection alarm to be activated.

15. The apparatus of claim 1, wherein the presence detection device includes one of a mechanical switch, an electro-mechanical switch, an electrical switch, a pressure sensor, and weight sensor, an optical sensor, and electro-optical sensor, a vibration sensor, and an optical camera.

16. The apparatus of claim 15, wherein the presence detection device includes a weight sensor which detect the presence or absence of a body.

17. The apparatus of claim 15, wherein the presence detection device includes an optical camera connected with a computer running image detection algorithms which can detect the presence of a child, and which generates a secondary signal once detection of a human or face is determined causing the presence detection alarm to be activated.

18. The apparatus of claim 15, wherein the presence detection device includes a pair of electronic contacts spaced apart located at or under a seat cushion of the seat of the vehicle, whereby when a child sits on the seat cushion, the electrical contacts are connected and generate a secondary signal causing the presence detection alarm to be activated.

19. The apparatus of claim 1, wherein the presence detection device is positioned at the seat of the vehicle.

20. The apparatus of claim 1, wherein the alert is at least one of an audible, visual, or vibratory alert.

21. The apparatus of claim 1, wherein the presence detection alarm is located on a portable electronic device.

22. The apparatus of claim 21, wherein the portable electronic device is a smartphone.

23. The apparatus of claim 1, wherein the untethered coupling device is a smartphone which is electronically coupled with the tethered coupling device.

24. A method for providing an alert regarding an unattended child in a vehicle comprising:
generating a secondary signal upon detection of the child in the seat of the vehicle by a presence detection device;
activating a presence detection alarm upon detection of the child in the seat, indicating the presence of the child in the seat of the vehicle, wherein a tethered coupling device is connected with the seat via a tether, wherein the tethered coupling device is not coupled with an untethered coupling device when the presence of the child is detected, and wherein the untethered coupling device is connected with a caregiver of the child; and
deactivating the presence detection alarm upon detecting the presence of the child by bringing into contact and connecting the tethered coupling device with the untethered coupling device.

25. The method of claim 24, further comprising reactivating the presence detection alarm upon disconnecting the tethered coupling device from the untethered coupling device.

26. The method of claim 24, further comprising generating a primary signal upon connecting the tethered coupling device with the untethered coupling device.

27. The method of claim 24, wherein the tethered coupling device is connected with the stationary device via a tether.

28. The method of claim 24, wherein the tethered coupling device generates a primary signal, and wherein the primary signal travels through the tether to the electrical circuit located on the seat of the vehicle.

29. The method of claim 28, wherein the secondary signal also travels to electrical circuit located on the seat of the vehicle, and based upon the receipt of the primary and secondary signals, the electrical circuit either activates or deactivates the presence detection alarm.

30. An apparatus for providing an alert regarding an unattended child in a vehicle comprising:
a tethered coupling device connected with a stationary device at one end and removably coupled with a movable object at an opposing end; and
a presence detection device for detecting the presence of the child in a seat of the vehicle,
wherein the presence detection device is connected with a presence detection alarm,
wherein the tethered coupling device is not coupled with the movable object before the presence of a child is detected,
wherein once the presence of a child is detected in the seat of the vehicle by the presence detection device, the presence detection alarm is activated and generates an alert, and
wherein once the alert is generated and the tethered coupling device is coupled with the movable object, the presence detection alarm is deactivated.

31. The apparatus of claim 30, wherein the movable object is one of a caregiver, an item of clothing worn by the caregiver, or an item within the vehicle.

32. The apparatus of claim 31, wherein the movable object is one of a caregiver, a pocket on an item of clothing worn by the caregiver, a dress, a shirt, pants, a belt, a purse, a wallet, a seat belt, and a removable portion of a seat or child safety seat.

33. The apparatus of claim 30, wherein the tethered coupling device includes a clip.
